(19) United States
(12) Patent Application Publication
(10) Pub. No.: US 2024/0121197 A1
(43) Pub. Date: Apr. 11, 2024

(54) NETWORK APPARATUS, METHOD, AND NON-TRANSITORY COMPUTER-READABLE MEDIUM HAVING PROGRAM STORED THEREIN

(71) Applicant: NEC Corporation, Minato-ku, Tokyo (JP)

(72) Inventor: Yoshihiko Hoshino, Tokyo (JP)

(73) Assignee: NEC Corporation, Minato-ku, Tokyo (JP)

(21) Appl. No.: 18/276,788

(22) PCT Filed: Mar. 26, 2021
(86) PCT No.: PCT/JP2021/012883

§ 371 Date: Aug. 10, 2023

(51) Int. Cl. H04L 47/193

(52) U.S. Cl. CPC H04L 47/193

(57) ABSTRACT

When a control signal transmitted from a session management functional unit receiving a connection instruction (for example, Attach or the like) of a terminal is received, a policy management functional unit of a network apparatus notifies a LAN located between a core network and the Internet of a policy for the terminal. Specifically, the policy management functional unit notifies the LAN of the policy via a TCP-based interface or an SCTP-based interface. The policy management functional unit receives the control signal via the TCP-based interface or the SCTP-based interface.

### TECHNICAL FIELD

The present disclosure relates to a network apparatus, a method, and a non-transitory computer-readable medium storing a program.

### BACKGROUND ART

In an evolved packet core (EPC), a packet data network gateway (P-GW) is provided as a component (functional unit) that transmits and receives a user packet to and from an external Internet (for example, Patent Literature 1). A Gi-local area network (LAN) is provided between the EPC and the Internet.

### CITATION LIST

### Patent Literature

[Patent Literature 1] Japanese Unexamined Patent Application Publication No. 2017-92542

### SUMMARY OF INVENTION

### Technical Problem

The EPC is provided with a policy and charging rules function (PCRF) as a functional unit (policy management functional unit) for managing a policy. When the P-GW receives a connection instruction (Attach or the like) of user equipment (UE) being transmitted from a mobility management entity (MME) via a serving gateway (S-GW), the P-GW transmits the connection instruction to the Gi-LAN. When the connection instruction is received from the P-GW, the Gi-LAN executes a procedure for acquiring a policy from the PCRF. This policy is a policy defined as a contract between a user and a carrier.

However, a remote authentication dial in user service (Radius) is a de facto standard as a protocol to be used when the P-GW transmits the connection instruction to the Gi-LAN. The Radius lacks reliability because of using a user datagram protocol (UDP). Therefore, the connection instruction transmitted from the P-GW to the Gi-LAN may not reach the Gi-LAN, and as a result, the Gi-LAN may be notified of no policy from the PCRF. In this case, no policy may be reflected in the Gi-LAN and either a user or a carrier may suffer a loss related to charging. This problem may occur not only in the EPC, but also in a core network (5G core (5GC)) of a 5G system, and a network in which the EPC and the 5GC coexist. Herein, the MME, the P-GW, and a serving gateway (S-GW) of the EPC are associated to a session management function (SMF) and an access and mobility management function (AMF) of the 5GC, and the PCRF of the EPC is associated to a policy control function (PCF) of the 5GC.

An object of the present disclosure is to provide a network apparatus, a method, and a non-transitory computer-readable medium storing a program that are able to reliably reflect a policy in a LAN located between a core network and the Internet.

### Solution to Problem

A network apparatus according to a first aspect is a network apparatus of a core network and includes a policy management functional unit configured to manage a policy for a terminal, and,

when a control signal transmitted from a session management functional unit receiving a connection instruction of the terminal is received via a transmission control protocol (TCP)-based interface or a stream control transmission protocol (SCTP)-based interface, the policy management functional unit notifies a local area network (LAN) located between the core network and the Internet of the policy via the TCP-based interface or the SCTP-based interface.

A method according to a second aspect is a method to be performed by a network apparatus of a core network,
the network apparatus includes a policy management functional unit configured to manage a policy for a terminal, and
the method includes notifying, by the policy management functional unit, when a control signal transmitted from a session management functional unit receiving a connection instruction of the terminal is received via a transmission control protocol (TCP)-based interface or a stream control transmission protocol (SCTP)-based interface, a local area network (LAN) located between the core network and the Internet of the policy via the TCP-based interface or the SCTP-based interface.

A non-transitory computer-readable medium according to a third aspect is a non-transitory computer-readable medium storing a program causing a network apparatus of a core network to perform processing,
the network apparatus includes a policy management functional unit configured to manage a policy for a terminal, and
the processing includes notifying, by the policy management functional unit, when a control signal transmitted from a session management functional unit receiving a connection instruction of the terminal is received via a transmission control protocol (TCP)-based interface or a stream control transmission protocol (SCTP)-based interface, a local area network (LAN) located between the core network and the Internet of the policy via the TCP-based interface or the SCTP-based interface.

### Advantageous Effects of Invention

The present disclosure can provide a network apparatus, a method, and a non-transitory computer-readable medium storing a program that are able to reliably reflect a policy in a LAN located between a core network and the Internet.

### BRIEF DESCRIPTION OF DRAWINGS

FIG. 1 is a block diagram illustrating an example of a network apparatus of a core network in a first example embodiment;

FIG. 2 is a schematic diagram of a 5G core;

FIG. 3 is a block diagram illustrating an example of a network apparatus of a 5G core in a second example embodiment;

FIG. 4 is a sequence diagram for explaining a processing operation of the network apparatus of the 5G core in the second example embodiment;

FIG. 5 is a schematic diagram of an EPC;

FIG. 6 is a block diagram illustrating an example of a network apparatus of an EPC in a third example embodiment;

FIG. 7 is a sequence diagram for explaining a processing operation of the network apparatus of the EPC in the third example embodiment; and

FIG. 8 is a diagram illustrating a hardware configuration example of a network apparatus.

### EXAMPLE EMBODIMENT

Hereinafter, example embodiments are described with reference to the drawings. In the example embodiments, the same or equivalent elements are denoted by the same reference numerals, and redundant descriptions are omitted.

### First Example Embodiment

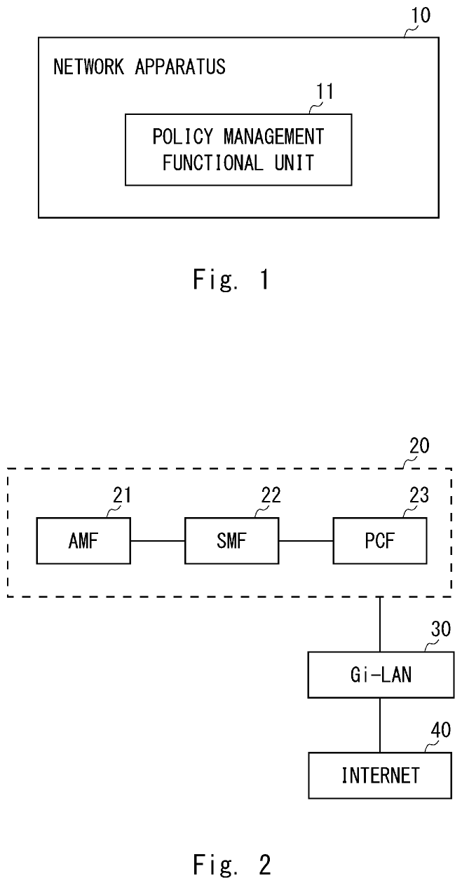

FIG. 1 is a block diagram illustrating an example of a network apparatus of a core network in a first example embodiment. In FIG. 1 a network apparatus 10 includes a policy management functional unit 11.

The policy management functional unit 11 manages a policy for a terminal (not illustrated). For example, when a control signal transmitted from a session management functional unit (not illustrated) having received a connection instruction (for example, Attach or the like) of the terminal (not illustrated) is received, the policy management functional unit 11 notifies a “local area network (LAN)” (not illustrated) located between a core network and the Internet of a policy for the terminal (not illustrated). Specifically, the policy management functional unit 11 may notify the above “local area network (LAN)” of this policy via a transmission control protocol (TCP)-based interface or a stream control transmission protocol (SCTP)-based interface. The LAN may be referred to as a Gi-LAN.

Note that the policy management functional unit 11 normally receives the above control signal via the transmission control protocol (TCP)-based interface or the stream control transmission protocol (SCTP)-based interface.

It is also conceivable to perform a procedure in which a session management functional unit (not illustrated) transmits a control signal to the Gi-LAN by using a remote authentication dial in user service (Radius) and the Gi-LAN acquires a policy from the policy management functional unit 11 in response to the control signal. However, the Radius lacks reliability because it uses a user datagram protocol (UDP). Therefore, a connection instruction transmitted from a P-GW to the Gi-LAN may not reach the Gi-LAN and as a result, the Gi-LAN may be notified of no policy from a PCRF. In this case, no policy may be reflected in the Gi-LAN and either a user or a carrier may suffer a loss related to charging.

On the other hand, in the network apparatus 10, when a control signal transmitted from a session management functional unit (not illustrated) having received a connection instruction (for example, Attach or the like) of a terminal (not illustrated) is received, the policy management functional unit 11 notifies the Gi-LAN of a policy for the terminal (not illustrated). The policy management functional unit 11 receives the above control signal via the transmission control protocol (TCP)-based interface or the stream control transmission protocol (SCTP)-based interface. The TCP-based interface or the SCTP-based interface is used for this notification. In this way, by using, as a trigger, the reception of the control signal from the session management functional unit (not illustrated) via a protocol-based interface that guarantees communication reliability, the policy management functional unit 11 notifies the Gi-LAN of a policy for the terminal (not illustrated) via the protocol-based interface that guarantees communication reliability, so that the policy can be reliably reflected in the Gi-LAN.

### Second Example Embodiment

The second example embodiment relates to a more specific example embodiment. In the second example embodiment, particularly, a case where a core network is a core network of a 5G system (5G core (5GC)) is described.

<Overview of 5G Core>

FIG. 2 is a schematic diagram of the 5G core. In FIG. 2, a 5G core 20 includes an access and mobility management function (AMF) 21, a session management function (SMF) 22, and a policy control function (PCF) 23.

The AMF 21 is a functional unit that performs registration management, connection management, and mobility management.

The SMF 22 is a functional unit that performs session management.

The PCF 23 is a functional unit that manages policies and rules.

As illustrated in FIG. 2, a Gi-LAN 30 is provided between the 5G core 20 and the Internet 40.

### Configuration Example of Network Apparatus

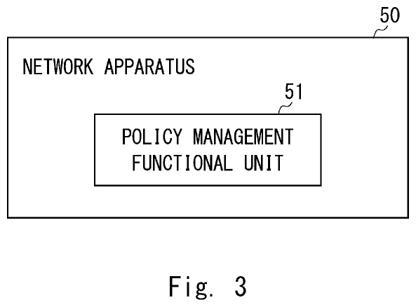

FIG. 3 is a block diagram illustrating an example of a network apparatus of the 5G core in the second example embodiment. In FIG. 3, a network apparatus 50 includes a policy management functional unit 51. The policy management functional unit 51 corresponds to the PCF 23 in FIG. 2.

As with the policy management functional unit 11 of the first example embodiment, when a control signal transmitted from a session management functional unit (corresponding to the above SMF 22) having received a connection instruction (for example, Attach or the like) of a terminal (not illustrated) is received, the policy management functional unit 51 notifies the Gi-LAN 30 of a policy for the terminal (not illustrated). Specifically, the policy management functional unit 51 notifies the Gi-LAN 30 of this policy via a transmission control protocol (TCP)-based service-based interface (SBI). The above “control signal” may be a policy control request message (for example, Npcf_SMPolicyControl_Request).

### Operation Example of 5G Core

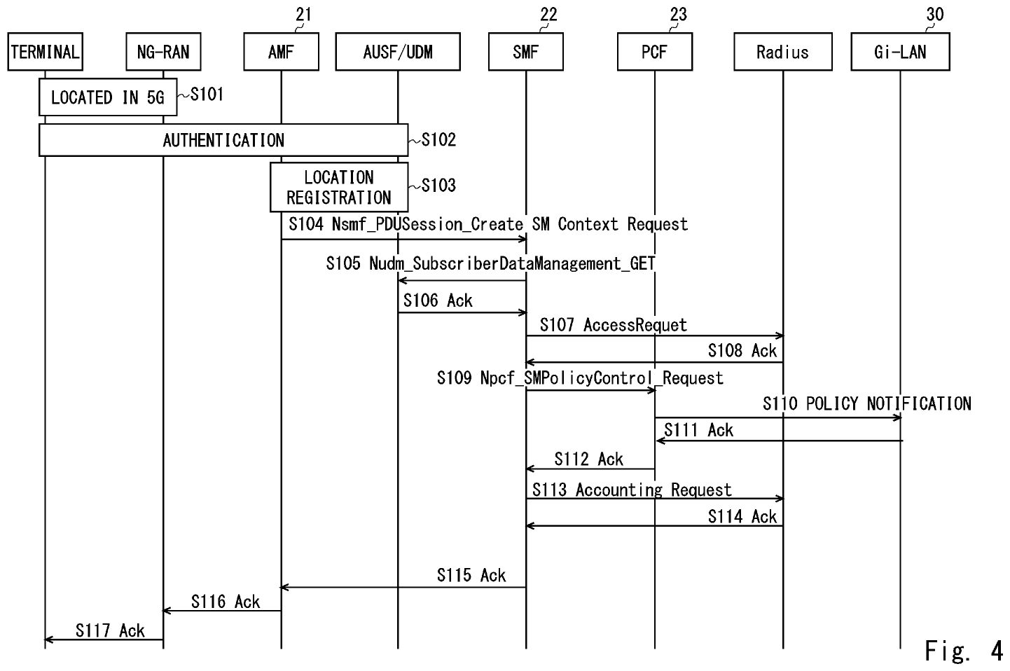

FIG. 4 is a sequence diagram for explaining a processing operation of the network apparatus of the 5G core in the second example embodiment.

As illustrated in FIG. 4, a terminal is located in a 5G area and is connected to a NG-RAN (Radio Access Network) (step S101). Subsequently, the terminal is authenticated by an authentication server function (AUSF) (step S102). Subscriber contract information and authentication information held in unified data management (UDM) is used for this authentication. Subsequently, the AMF 21 performs location registration of the terminal (step S103).

The AMF 21 transmits a Nsmf_PDUSession_CreateSMContext Request message to the SMF 22 (step S104). For example, the Nsmf_PDUSession_CreateSMContext Request message corresponds to the above connection instruction of the terminal (not illustrated), which is received by the SMF 22.

The SMF 22 transmits a Nudm_SubscriberDataManagement_GET message to the UDM (step S105), and the UDM transmits an Ack to the SMF 22 (step S106). Thus, the SMF 22 can acquire subscriber information and the like about the terminal.

The SMF 22 transmits an Access Request to the Radius (step S107), and the Radius transmits an Ack to the SMF 22 (step S108).

The SMF 22 transmits a Npcf_SMPolicyControl_Request message to the PCF 23 (step S109). The Npcf_SMPolicyControl_Request message corresponds to the above control signal transmitted by the SMF 22 to the PCF 23 (that is, the policy management functional unit 51).

The PCF 23 transmits a policy notification to the Gi-LAN 30 (step S110). The Gi-LAN 30 transmits an Ack to the PCF 23 (step S111). The PCF 23 transmits an Ack to the SMF 22 (step S110).

The SMF 22 transmits an Accounting Request to the Radius (step S113), and the Radius transmits an Ack to the SMF 22 (step S114).

The SMF 22 transmits an Ack to the AMF 21 (step S115). The AMF 21 transmits an Ack to the terminal via a NG-RAN (steps S116 and S117).

### Third Example Embodiment

The third example embodiment relates to a more specific example embodiment. In the third example embodiment, particularly, a case where a core network is an EPC is described.

<Overview of EPC>

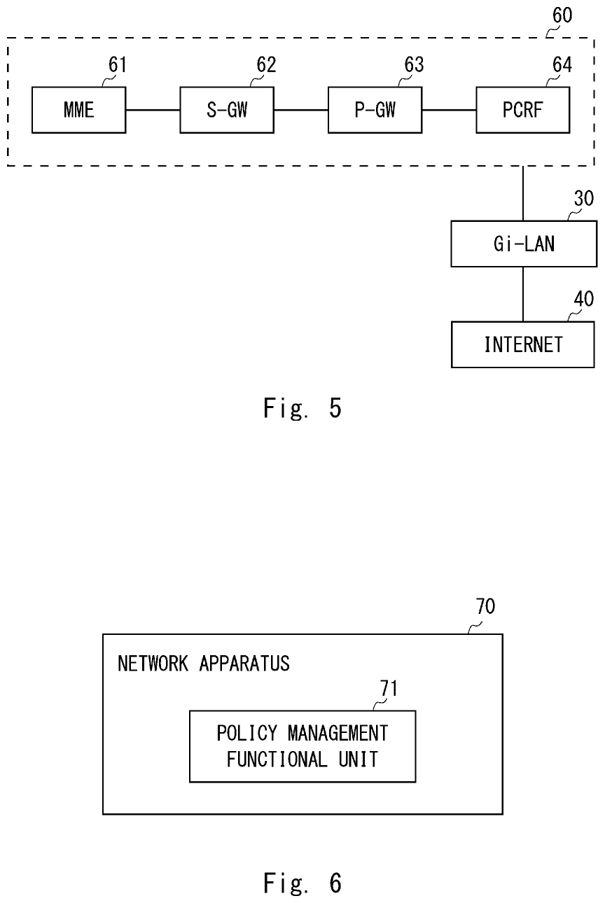

FIG. 5 is a schematic diagram of the EPC. In FIG. 5, an EPC 60 includes a mobility management entity (MME) 61, a serving gateway (S-GW) 62, a packet data network gateway (P-GW) 63, and a policy and charging rules function (PCRF) 64.

The MME 61 is a functional unit that performs mobility management and session management.

The S-GW 62 is a functional unit that is connected to a U-plane between an E-UTRAN and the EPC 60 and performs routing and transfer of user packets.

The P-GW 63 is a functional unit that serves as a connection point with an external IP network and transfers user packets to and from the external IP network.

The PCRF 64 is a functional unit that manages policies and charging.

### Configuration Example of Network Apparatus

FIG. 6 is a block diagram illustrating an example of a network apparatus of the EPC in the third example embodiment. In FIG. 6, a network apparatus 70 includes a policy management functional unit 71. The policy management functional unit 71 corresponds to the PCRF 64 in FIG. 5.

As with the policy management functional unit 11 of the first example embodiment, when a control signal transmitted from a session management functional unit (corresponding to the above MME 61) having received a connection instruction (for example, Attach or the like) of a terminal (not illustrated) is received, the policy management functional unit 71 notifies the Gi-LAN 30 of a policy for the terminal (not illustrated). Specifically, the policy management functional unit 71 notifies the Gi-LAN 30 of this policy via an SCTP-based Diameter interface. A Re-Auth-Request (RAR) may be used for this notification. The above “control signal” may be a credit control message (for example, credit control (CC) request).

### Operation Example of EPC

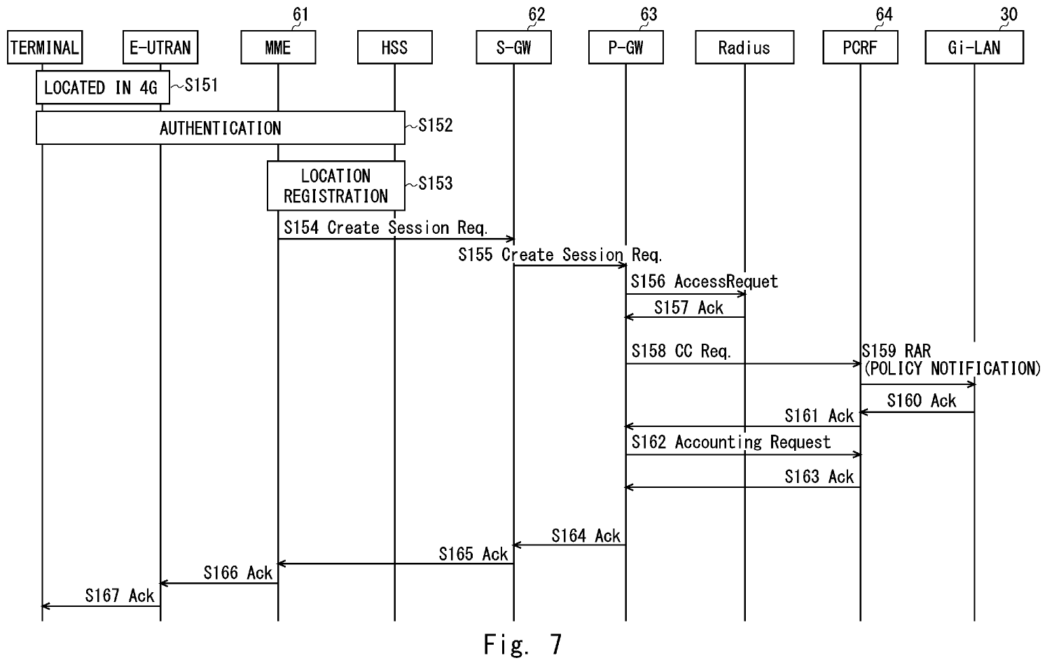

FIG. 7 is a sequence diagram for explaining a processing operation of the network apparatus of the EPC in the third example embodiment.

As illustrated in FIG. 7, a terminal is located in a 4G area and is connected to the E-UTRAN (step S151). Subsequently, the terminal is authenticated using subscriber contract information and authentication information held in a home subscriber server (HSS) (step S152). Subsequently, the MME 61 performs location registration of the terminal (step S153).

The MME 61 transmits a Create Session Request message to the S-GW 62 (step S154). Subsequently, the S-GW 62 transmits the Create Session Request message to the P-GW 63 (step S155). For example, the Create Session Request message corresponds to the above connection instruction of the terminal (not illustrated), which is received by the PCRF 64.

The P-GW 63 transmits an Access Request to the Radius (step S156), and the Radius transmits an Ack to the P-GW 63 (step S157).

The P-GW 63 transmits a Credit Control (CC) Request message to the PCRF 64 (step S158). For example, the Credit Control (CC) Request message corresponds to the above control signal received by the PCRF 64.

The PCRF 64 transmits a Re-Auth-Request (policy notification) to the Gi-LAN 30 (step S159). The Gi-LAN 30 transmits an Ack to the PCRF 64 (step S160). The PCRF 64 transmits an Ack to the P-GW 63 (step S161).

The P-GW 63 transmits an Accounting Request to the PCRF 64 (step S162), and the PCRF 64 transmits an Ack to the P-GW 63 (step S163).

The P-GW 63 transmits an Ack to the S-GW 62 (step S164). The S-GW 62 transmits an Ack to the MME 61 (step S165). The MME 61 transmits an Ack to the terminal via the E-UTRAN (steps S166 and S167).

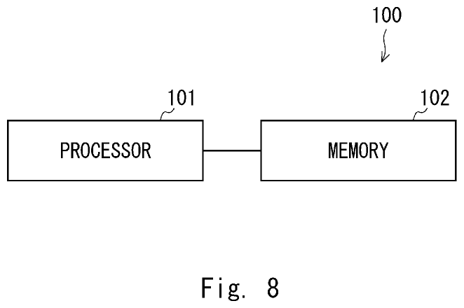

### Other Example Embodiments

<1> In the second example embodiment, the 5G core alone has been described, and in the third example embodiment, the EPC alone has been described; however, the present disclosure is not limited thereto and it is of course that the 5G core and the EPC may coexist and be connected to each other. In this case, a combination (SMF-P-GW) of the SMF and the P-GW may be one component of the 5G core. In this case, when a terminal exists in a 5G area, the AMF transmits a connection instruction to the SMF-P-GW, the SMF-P-GW transmits a control signal to the PCF, and the PCF notifies the Gi-LAN of a policy. On the other hand, when the terminal exists in a 4G area, the MME transmits a connection instruction to the SMF-P-GW, the SMF-P-GW transmits a control signal to the PCRF, and the PCRF notifies the Gi-LAN of a policy.

<2>FIG. 8 is a diagram illustrating a hardware configuration example of a network apparatus. In FIG. 8, a network apparatus 100 includes a processor 101 and a memory 102. The processor 101 may be, for example, a microprocessor, a micro processing unit (MPU), or a central processing unit (CPU). The processor 101 may include a plurality of processors. The memory 102 is composed of a combination of a volatile memory and a nonvolatile memory. The memory 102 may include a storage spaced apart from the processor 101. In this case, the processor 101 may access the memory 102 via an I/O interface (not illustrated).

Each of the network apparatuses 10, 50, and 70 of the first example embodiment to third example embodiment may have the hardware configuration illustrated in FIG. 8. The policy management functional units 11, 51, and 71 of the network apparatuses 10, 50, and 70 of the example embodiment to third example embodiment may be implemented by the processor 101 that reads and executes a program stored in the memory 102. The program can be stored using various types of non-transitory computer-readable media, and supplied to the network apparatuses 10, 50, and 70. Examples of the non-transitory computer-readable medium include magnetic recording media (for example, flexible disks, magnetic tapes, and hard disk drives), and magnetooptical recording media (for example, magnetooptical disks). Examples of the non-transitory computer-readable medium further include CD-ROMs (Read Only Memories), CD-Rs, and CD-R/Ws. Examples of the non-transitory computer-readable medium further include semiconductor memories. The semiconductor memories include, for example, mask ROMs, programmable ROMs (PROMs), erasable PROMs (EPROMs), flash ROMs, and random access memories (RAMs). The program may also be supplied to the network apparatuses 10, 50, and 70 via various types of transitory computer-readable media. Examples of the transitory computer-readable media include electrical signals, optical signals, and electromagnetic waves. The transitory computer-readable medium can supply the program to the network apparatuses 10, 50, and 70 via wired communication channels such as electrical wires and optical fibers, or wireless communication channels.

The present invention has been described with reference to the embodiments, but the present invention is not limited to the above. Various changes that can be understood by a person skilled in the art within the scope of the invention can be made to the configurations and details of the present invention.

### REFERENCE SIGNS LIST

10 NETWORK APPARATUS
11 POLICY MANAGEMENT FUNCTIONAL UNIT
20 5G CORE
21 AMF
22 SMF
23 PCF
30 Gi-LAN
40 INTERNET
50 NETWORK APPARATUS
51 POLICY MANAGEMENT FUNCTIONAL UNIT
60 EPC
61 MME
62 S-GW
63 P-GW
64 PCRF
70 NETWORK APPARATUS
71 POLICY MANAGEMENT FUNCTIONAL UNIT

What is claimed is:

1. A network apparatus of a core network, the network apparatus comprising:
at least one memory storing instructions, and
at least one processor configured to execute, according to the instructions, a process comprising:
managing a policy for a terminal,
notifying, when a control signal transmitted from a session management functional unit receiving a connection instruction of the terminal is received via a transmission control protocol (TCP)-based interface or a stream control transmission protocol (SCTP)-based interface, the policy management functional unit notifies a local area network (LAN) located between the core network and the Internet of the policy via the TCP-based interface or the SCTP-based interface.

2. The network apparatus according to claim 1, wherein
the core network is a 5G core network, and
the policy management functional unit notifies the LAN of the policy via a TCP-based service-based interface.

3. The network apparatus according to claim 1, wherein the policy management functional unit is a policy control function (PCF).

4. The network apparatus according to claim 1, wherein the control signal is a policy control request message.

5. The network apparatus according to claim 1, wherein
the core network is an evolved packet core (EPC), and
the policy management functional unit notifies the LAN of the policy via an SCTP-based Diameter interface.

6. The network apparatus according to claim 5, wherein the policy management functional unit is a policy and charging rules function (PCRF).

7. The network apparatus according to claim 1, wherein the control signal is a credit control message.

8. A method to be performed by a network apparatus of a core network, the method comprising:
managing a policy for a terminal, and
notifying, when a control signal transmitted from a session management functional unit receiving a connection instruction of the terminal is received via a transmission control protocol (TCP)-based interface or a stream control transmission protocol (SCTP)-based interface, a local area network (LAN) located between the core network and the Internet of the policy via the TCP-based interface or the SCTP-based interface.

9. A non-transitory computer-readable medium storing a program causing a network apparatus of a core network to perform a process, the process comprising:
managing a policy for a terminal, and
notifying, when a control signal transmitted from a session management functional unit receiving a connection instruction of the terminal is received via a transmission control protocol (TCP)-based interface or a stream control transmission protocol (SCTP)-based interface, a local area network (LAN) located between the core network and the Internet of the policy via the TCP-based interface or the SCTP-based interface.
